(19) United States
(12) Patent Application Publication
(10) Pub. No.: US 2024/0351842 A1
(43) Pub. Date: Oct. 24, 2024

(54) METHOD FOR SECURING A STOPPER ON A CONTAINER, SECURING STATION FOR SECURING A CONTAINER CLOSED BY A STOPPER

(71) Applicant: TT Innovation AG, Zug (CH)

(72) Inventor: Franco Seppi, Basel (CH)

(73) Assignee: TT Innovation AG, Zug (CH)

(21) Appl. No.: 18/644,199

(22) Filed: Apr. 24, 2024

(30) Foreign Application Priority Data
Apr. 24, 2023 (DE) 102023110324.5

(51) Int. Cl. B67B 1/08; A61J 1/14; B65B 57/00

(52) U.S. Cl. CPC B67B 1/08; A61J 1/1412; B65B 57/00

(57) ABSTRACT

A method for securing a stopper on a container using a closure cover with the aid of a securing station, in which, during the securing, carries out measurements of quantities, in particular movement quantities, about an axis in order to assess the securing operation, and the detected measured values are assessed in order to detect insufficiently secured containers.

### CROSS-REFERENCE TO RELATED APPLICATIONS

This application claims priority from German Patent Application No. 10 2023 110 324.5, filed Apr. 24, 2023, which is incorporated herein by reference as if fully set forth.

### TECHNICAL FIELD

The invention relates to a method for securing a stopper on a container by means of a closure cover, wherein the container is preferably a pharmaceutical or medical container, wherein, during the securing, a relative movement at least between the closure cover and a securing tool about an axis is performed.

The invention also relates to a securing station for securing a container, closed by a stopper, by means of a closure cover, wherein the container is preferably a pharmaceutical or medical container, wherein the container and the closure cover are arranged so as to be movable relative to one another along an axis, wherein the securing station has at least one securing tool for securing purposes.

### BACKGROUND

It is known from practice for pharmaceutical or medical containers to be secured by means of stoppers and closure covers.

### SUMMARY

The invention is based on the object of securing medical or pharmaceutical containers by means of a stopper and a closure cover in such a way that contaminants outside the container do not come into contact with the contents of the container due to the high tightness of the closure cover.

In order to achieve this object, the invention proposes a method for securing a stopper on a container having one or more of the features disclosed herein, and in particular, a method for securing a stopper on a container using a closure cover, that, during the securing, a detection, in particular a measurement and/or determination, of a quantity determined at least by a relative movement between the container and the closure cover about the axis is carried out.

The invention makes it possible to monitor a quality of a transmission of movement between constituent parts that must be synchronous and/or be in a predefined relationship relative to one another for proper securing. This allows conclusions to be drawn as to whether the securing has been effected according to a specification or whether unforeseen and/or undesired deviations have occurred. The mentioned quantity can thus be used in a simple manner in order to check the quality already during the securing process. Subsequent, for example optical, checks can thus be supplemented and/or even replaced or at least simplified.

The detection may, for example, be a measurement and/or a determination. In the case of a measurement, it is thus for example possible to obtain a measured quantity that can be readily processed. In the case of a determination, it is for example possible for deviations from a specified value to be usable for a quality statement.

In this case, the securing may, for example, be the fluidic closing and/or sealing of the contents of the container.

Here, the detected quantity may be equal to the relative movement (slip) between the closure cover and the container, particularly if the closure cover and the container are mounted in their respective receptacles in a slip-free manner. However, there may also be further contributions to the quantity, in particular slip between the closure cover and its receptacle and/or slip between the container and its receptacle.

The detected quantity may, for example, also be an absolute rotational speed on the part of the closure cover, which is compared with a drive-side setpoint rotational speed. Here, the detected quantity thus includes a relative movement between the container and the closure cover and, as further input quantity, the setpoint rotational speed and is determined by these. The quantity may additionally be determined by a relative movement between an assigned receptacle and the container and/or between an assigned receptacle and the closure cover. The resultant formula is thus

nₘ=nₐ+D_{bv}+D_{b}+Dᵥ,
where
   nₘ=rotational speed on the concomitantly operating side
   nₐ=rotational speed on the driving side
   D_{bv}=slip (relative movement) between container and closure cover
   D_{b}=slip between container and associated (coupled) receptacle
   Dᵥ=slip between closure cover and associated (coupled) receptacle.

The quantity nₘ is therefore determined at least by D_{bv}, here even additionally by nₐ, D_{b} and Dᵥ.

In an alternative, which can also be combined with the described solution, in order to achieve the stated object, provision may be made in a method of the type mentioned in the introduction that, during the securing, a detection, in particular a measurement and/or determination, of a quantity determined at least by a rotationally connected coupling of the container is carried out.

Here, the rotationally connected coupling of the container may be formed by a coupling of a receptacle which contacts the container, for example the lower and/or driving receptacle described below, to the container. A coupling to a drive is thus achievable.

In a further alternative, which can also be combined with one or both of the described solutions, in order to achieve the stated object, provision may be made in a method of the type mentioned in the introduction that, during the securing, a detection, in particular a measurement and/or determination, of a quantity determined at least by a rotationally connected coupling of the closure cover is carried out.

Here, the rotationally connected coupling of the closure cover may be formed by a coupling of a receptacle which contacts the closure cover, for example the upper and/or concomitantly operating receptacle described below, to the closure cover. A coupling to an abutment is thus achievable.

It has been shown that the receptacles can become soiled in use, with the result that slip may occur more frequently at one of the couplings. For many cases, monitoring of this slip is of considerable significance for assessing a correctly executed securing operation.

It is thus particularly advantageous that a correlate between the relative movement between the container and the closure cover about the axis and the quality of the securing is possible via the measurable and/or determinable quantity.

In this way, non-sufficient closing of the container by means of the closure cover can also advantageously be detected in a timely manner and a reject can be prevented.

By way of example, provision may be made for the determined quantity of the relative movement to be used by a quality management system in particular to analyze and assess the quality of the method.

In an advantageous refinement, provision may be made for the quantity to be effected by measurement of a preferably rotary relative movement between a receptacle which supports, preferably drives, the container, preferably the lower receptacle, and a preferably concomitantly operating receptacle which receives the closure cover, preferably upper receptacle.

In this case, provision may for example be made for the stopper to be sufficiently secured on the container by means of the closure cover as soon as the rotational movement of the concomitantly operating receptacle is synchronous with the rotational movement of the driving receptacle or lies within a tolerance band.

It is thus particularly advantageous that a comparison of the rotational movements of the driving receptacle and of the concomitantly operating receptacle is possible in order to assess the quality of the securing.

In an advantageous refinement, provision may be made for the quantity to be an absolute value on the concomitantly operating side and/or driving side, a time between pulses at an encoder, a travelled angle and/or a rotational speed, preferably in each case in comparison with a setpoint value. It is alternatively or additionally possible to also detect acceleration values.

Here, provision may for example be made for the driving receptacle to be driven by way of a motor, wherein the setpoint value is for example a set rotational speed of the motor, wherein for example the quantity of the absolute value of the concomitantly operating receptacle is measured and/or determined and compared with the setpoint value.

It is thus particularly advantageous that very precise reference measurements are possible and deviations between the setpoint value and the absolute value can be ascertained quickly. In this case, the comparison may also advantageously provide insight into how the method should be adapted in order to generate a virtually identical movement of the driving side and concomitantly operating side.

In an advantageous refinement, provision may be made for the quantity to be determined from a measurement of a relative movement of a lower and/or driving receptacle in relation to a closure cover of the medical container. It is thus for example possible for slip between the closure cover and the container and/or slip between the container and the driving receptacle to be detected.

In an advantageous refinement, provision may be made for the quantity to be determined from a measurement of a relative movement of an upper and/or concomitantly operating receptacle in relation to a medical container. It is thus possible for slip between the closure cover and the container to be detected when the concomitantly operating receptacle bears against the closure cover.

In an advantageous refinement, provision may be made for the quantity to be determined from a measurement of a relative movement of a closure cover, for example of the already mentioned closure cover, in relation to a container, for example the already mentioned container. It is thus possible for slip between closure cover and container to be detected. Such slip must not occur in the case of fixed “crimping” or securing.

The term crimping is understood to mean, for example, a joining method in which two components are connected to one another by plastic deformation, for example by flanging, squeezing, curling or folding.

In particular, a lower edge of the closure cover may be flanged.

In an advantageous refinement, provision may be made for the quantity to be determined from a measurement of a crimping disc in relation to a container, for example the already mentioned container. It is thus possible for slip between the crimping disc and the closure cover and/or slip between the closure cover and the container to be detected.

In an advantageous refinement, provision may be made for the quantity to be determined from a measurement of a crimping disc, for example of the already mentioned crimping disc, in relation to an upper and/or concomitantly operating receptacle, for example the already mentioned upper and/or concomitantly operating receptacle. It is thus possible for proper running of the crimping disc on the closure cover to be detected.

By way of example, the rotation of the closure cover may be detectable via markings on the closure cover. By way of example, the rotation of the container may be detectable via markings on the container.

By way of example, a rotation of the driving receptacle may be fixedly predefined.

A rotation of the concomitantly operating receptacle may be detectable for example by a coupled measuring device.

It is thus particularly advantageous that various possibilities for determining and/or measuring the quantity of the relative movement can be implemented.

In an advantageous refinement, provision may be made for the container with stopper and closure cover to be compressed by an upper and/or concomitantly operating receptacle on the one side and a lower and/or driving receptacle on the other side, such that a rotational movement of the lower, preferably driving receptacle is transmitted to the upper, preferably concomitantly operating receptacle.

It is thus advantageous for a releasable coupling between the lower and upper receptacles to be implemented, as a result of which in particular the rotational movement of the upper receptacle can be compared with the rotational movement of the lower receptacle and be assessed.

In an advantageous refinement, provision may be made for the driving receptacle to engage with the container from below and/or for the concomitantly operating receptacle to engage with said container from above.

It is thus advantageous for there to be as few interfering contours as possible on the upper receptacle for optimal transmission of the movement of the driving lower receptacle, said interfering contours potentially negatively influencing a preferably directed air flow within a clean room, in which the securing method preferably runs. This would often be the case if the motor is arranged on the upper receptacle.

As an alternative or in addition, the features of the additional independent claim, which is directed to a method, are provided according to the invention in order to achieve the stated object. In particular, in order to achieve the stated object, it is thus proposed, in a method for securing a stopper on a container by means of a closure cover of the type described in the introduction, that a quantity determined by a relative movement of a container, for example of the already mentioned container, in particular vial, and of a closure cover, for example of the already mentioned closure cover, is ascertained and compared with at least one rotational drive movement of at least one of the receptacles. A comparison with the rotational drive movements of both receptacles is preferably effected.

It is particularly advantageous that a comparison of the rotational drive movements makes it possible to identify deviations with respect to the relative movement and to initiate corresponding countermeasures. It is thus also advantageous that the number of incorrectly secured containers can be reduced.

In an advantageous refinement, provision may be made for the container to be driven and/or for the closure cover to operate concomitantly.

It is thus particularly advantageous that only one drive is required.

In an advantageous refinement, provision may be made for a measured value of a movement quantity of the relative movement, in particular a rotational speed and/or a torque and/or a pulse spacing, of container, receptacle(s), crimping disc (for example flanging disc) and/or closure cover to be detected.

It is thus advantageously possible for the measured values, which are compared for example with a setpoint value, to be able to be detected at different positions or locations.

By way of example, provision may also be made for measured values to be detected simultaneously at multiple locations, advantageously making it possible to validate and verify the detected measured values.

In an advantageous refinement, provision may be made that, during the detection, a setpoint value of the movement quantity is provided by a specification, in particular wherein the setpoint value of a driving side of the container is provided and/or the setpoint value is compared with an ACTUAL value of a concomitantly operating side, for example of the already mentioned concomitantly operating side.

It is particularly advantageous that, in the case of deviations between the setpoint value and the actual value, it can be assumed that non-sufficient securing of the closure cover on the container has been effected, as a result of which in turn a reject can be quickly detected and/or prevented. It is also advantageous that corresponding countermeasures can be initiated in the case of deviations of the actual value from the setpoint value. A countermeasure could for example be that the container, in particular the vial, again passes through a crimping process or at least parts thereof.

In a further advantageous refinement, provision may be made that, during the detection, a reference value of the movement quantity, in particular on the drive side of the container, is measured.

In this case, provision may for example be made for the movement quantity of the driving side to be measured and used as a reference value for the concomitantly operating side.

It is particularly advantageous that the reference value can be used to initiate a setpoint specification for the movement quantity, as a result of which in turn this setpoint value can be compared with a measured actual value of the movement quantity for the concomitantly operating side.

In an advantageous refinement, provision may be made for a difference value to be ascertained from the measured value and the setpoint value and/or the reference value and in particular assessed.

It is advantageous that the assessment of the difference value makes it possible to quickly identify and avoid possible incorrect settings, as a result of which in turn a more effective and more cost-effective method can be produced.

In an advantageous refinement, provision may be made that, as a result of the assessment, a notification is issued, particularly if the difference value has reached a certain value.

In this case, the value may, for example, be a preset upper and/or lower limit value that deviates from the setpoint value.

It is thus particularly advantageous that, in the case of a notification, the method can be interrupted in a timely manner, checked and examined for possible interfering factors in order to reduce further rejects.

In an advantageous refinement, provision may be made for the detection of the relative movement to be started prior to the securing and/or for the detection to be concluded after the securing, in particular wherein a detection time period comprises at least a time span of the securing.

It is thus particularly advantageous that the securing can be monitored over the entire time period and interventions can be carried out quickly in the case of possible deviations from setpoint values. It is also advantageous that countermeasures can be taken before a reject is produced. It is thus also advantageous that a more cost-effective method can be implemented.

Furthermore, it is thus for example advantageously already possible, prior to engagement of the securing tool, to identify whether the concomitantly operating receptacle is moving synchronously with the driving receptacle.

Furthermore, provision may for example be made for the securing to preferably begin only when it has been detected that the driving receptacle and the concomitantly operating receptacle are moving synchronously.

In an advantageous method sequence, the securing tool only starts the actual crimping (driving of the crimping disc into the aluminium cap) when the driving receptacle and the concomitantly operating receptacle are moving synchronously.

In an advantageous refinement, provision may be made that, prior to the securing, an acceleration of the relative movement, preferably of the concomitantly operating receptacle and/or of the driving receptacle, is detected. The detection of the acceleration prior to the securing is particularly advantageous, since this makes it possible to identify at an early stage, preferably prior to the engagement of the securing tool, interfering factors that could have a negative influence on the securing. Furthermore, it is thus advantageous that a reject can be prevented by virtue of the method being able to be interrupted in the case of a deviation of the acceleration.

Interfering factors which can be detected by the detection of the acceleration may, for example, be contaminants on the receptacles. In this case, the contaminants hinder in particular a slip-free transmission of movement between the driving receptacle and the concomitantly operating receptacle. The early identification makes it possible to avoid unintentional deformation of an incompletely fitted closure cover or damage to the container by the securing tool and/or the respective receptacle. A container for which the fitting of the closure cover was not able to be carried out successfully can thus be readily automatically fed back for fitting of the closure cover.

In an advantageous refinement, provision may be made for the detection of the movement quantity to be carried out on a side facing away from the container, preferably a side facing the or a closure cover.

It is advantageous that the focus of the detection of the movement quantity is thus in particular on the movement of the closure cover, as a result of which sufficient assessment of the quality of the securing is possible.

A preferred application of the invention provides that, in a method for securing a stopper on a container, in particular as described above, the container with the stopper and the closure cover are compressed against one another in a pressing direction and that a preferably signed force contribution of the securing, preferably in the pressing direction, is detected during the pressing.

The compression against one another advantageously makes it possible to transmit movement of a driving receptacle to a concomitantly operating receptacle.

It is also particularly advantageous that continuous force monitoring during the securing is thus possible, fluctuations in the acting forces being able to be quickly detected, assessed and preferably prevented.

In an advantageous refinement, provision may be made for a measurement of an application force of the securing tool, in particular of a crimping disc, for example of the already mentioned crimping disc, to be effected during a force contribution transversely with respect to the pressing direction.

It is particularly advantageous that it is thus possible to ascertain whether the pressing force of the securing tool, in particular of the crimping disc, is sufficient for the securing operation.

It is also advantageous that it is for example possible to ascertain whether and/or when a first engagement of the securing tool is effected.

In an advantageous refinement, provision may be made for a measurement of a restoring force of the securing tool, in particular of a crimping disc, for example of the already mentioned crimping disc, to be effected during a force contribution longitudinally with respect to the pressing direction.

It is particularly advantageous that it is thus possible, for example in the case of a decreasing force contribution longitudinally with respect to the pressing direction, to determine whether and/or when the securing tool is no longer in engagement.

In an advantageous refinement, provision may be made for a measurement of an adjustment path, in particular transversely with respect to the force contribution and/or longitudinally with respect to the force contribution, of the securing tool, in particular of the crimping disc, to be effected during a force contribution.

Provision may for example be made for the securing tool to travel a defined adjustment path in order to carry out the securing, wherein this adjustment path for example determines the path over which the securing tool must be moved, in particular for a first engagement.

It is particularly advantageous that, in addition and/or as an alternative to the measurement of the application force and restoring force, the adjustment path of the securing tool can be used to determine whether and/or when the securing tool is in engagement.

It is also advantageous that the application force can be varied by way of the adjustment path. It is thus for example possible for the measured application force of the securing tool and the measured adjustment path of said securing tool that correlates therewith to be compared.

In an advantageous refinement, provision may be made for a preferably axial compression force, in particular a force acting on the container, to be maintained during a detection time period of the force contribution, which comprises at least a time span of the securing.

Provision may for example be made for the axial compression force, which acts in particular on the container, to be measured, before the securing tool, in particular the crimping disc, is in engagement.

It is thus particularly advantageous that forces which act during the securing but are not caused by the axial compression force and have an additional influence on the axial compression force can be ascertained and evaluated.

In an advantageous refinement, provision may be made that, in order to maintain a or the compression force, the lower and/or concomitantly operating receptacle carries out an axial displacement, in particular during the time span of the securing.

Provision may for example be made for the lower and/or the upper receptacle to be driven pneumatically, for example by way of pneumatic cylinders which are for example designed with a control system, in particular with pneumatic valves, for generating a constant pneumatic pressure.

It is thus particularly advantageously possible to generate a sufficient axial compression force over the entire time span of the securing, as a result of which in turn the amount of containers that have not been secured on account of an insufficient compression force can be reduced. It is also advantageous that a defined axial compression force can be used to ensure that the stoppers are sufficiently compressed with the container and the containers are closed correctly. Excessive compression can thus be avoided. This can increase process reliability.

In an advantageous refinement, provision may be made for the force contribution to comprise a pressing force of the securing tool, in particular of the or a crimping disc, in particular wherein the pressing force is ascertained and assessed.

Provision may for example be made for a defined pressing force to be determined in order to ensure sufficient securing. It is for example also possible to define an upper and a lower limit value of the pressing force at which the securing can be carried out with few rejects.

The limit values may, for example, be ascertained by means of field tests and/or be determined by empirical values.

It is particularly advantageous that it is thus for example possible to identify in a timely manner if there is a pressing force that is not sufficient for the securing operation.

It is also advantageous that the assessment of the pressing force makes it possible to identify and/or prevent influences that cause errors.

In an advantageous refinement, provision may be made that, as a result of the assessment, a notification is issued, particularly if the pressing force exceeds a certain threshold value.

In this case, the exceedance of a certain threshold value may, for example, be the exceedance of a set upper limit value of the pressing force.

It is thus particularly advantageously possible to quickly identify, and indicate to a user, when the pressing force, for example the pressing force between the driving and the concomitantly operating receptacle, is too high, such that a preferably rotational movement of the receptacles is impaired. It is thus also advantageous that corresponding countermeasures can be initiated before the securing is carried out.

In an advantageous refinement, provision may be made that, as a result of the assessment, a notification is issued, particularly if the pressing force falls below a certain threshold value.

In this case, the falling below a certain threshold value may, for example, be the falling below a set lower limit value of the pressing force.

It is particularly advantageous that it is thus possible to identify at an early stage when the pressing force is too low for the securing, such that, for example by a movement of the lower receptacle, the pressing force can be correspondingly corrected.

In an advantageous refinement, provision may be made for the detection time period of the movement quantity and the detection time period of the force contribution to at least partially overlap in terms of time, in particular during the time span of the securing.

In this case, provision may for example be made for a measured value of a movement quantity of the relative movement to be detected in a same time period as, for example, a measured value of a pressing force.

It is thus advantageously possible to carry out a comparison of two physically different quantities which can be used to assess the overall securing.

In a further advantageous refinement, provision may be made for at least two methods to be able to be carried out in parallel, preferably independently of one another.

It is particularly advantageous that the securing can thus be carried out on multiple containers simultaneously and/or in a manner temporally offset relative to one another. It is thus also advantageously possible, for example when an error is detected, for the securing method at this securing station to be interrupted, wherein the at least one other securing method which is carried out in parallel can be continued without complications.

It is also advantageous that the cycle times can thus be reduced, as a result of which in turn the economic efficiency can be increased.

As an alternative or in addition, the features of the additional independent claim, which is directed to a securing station, are provided according to the invention in order to achieve the stated object. In particular, the invention thus proposes that the securing station has at least one sensor which is designed to detect a quantity determined at least by a relative movement between the container and the closure cover about the axis.

As an alternative or in addition, one or more of the features directed to a securing station, are provided according to the invention in order to achieve the stated object in the case of a securing station. In particular, it is thus proposed, supplementing or replacing the previous solution, that the securing station has at least one sensor which is designed to detect a quantity determined at least by a rotationally connected coupling of the container, in particular by a coupling of a receptacle which contacts the container to the container. This makes it possible to monitor the coupling to the receptacle, for example by a comparison of a rotational speed of the container with a rotational speed of the associated receptacle.

As an alternative or in addition to the previous solution, it is thus proposed that the securing station has at least one sensor which is designed to detect a quantity determined at least by a rotationally connected coupling of the closure cover, in particular by a coupling of a receptacle which contacts the closure cover to the closure cover. This makes it possible to monitor the coupling to the receptacle, for example by a comparison of a rotational speed of the closure cover with a rotational speed of the associated receptacle.

Here, provision may for example be made for the at least one sensor to measure a certain quantity of the relative movement about the axis of a lower and/or driving receptacle with respect to an upper and/or concomitantly operating receptacle.

It is particularly advantageous that the at least one sensor can be used to monitor different relevant quantities which allow a qualitative assessment of the securing.

In addition, provision may for example be made for at least one sensor, in particular a travel measuring sensor, to be designed to measure a distance of a movement which can occur on account of a compression of the container with the stopper and the closure cover.

In a further advantageous refinement, provision may be made for the container to be able to be positioned on a lower rotatable, preferably driving receptacle and for the closure cover to be able to be positioned on an upper rotatable, preferably concomitantly operating receptacle.

It is particularly advantageous that consequently only one receptacle has to be driven. Furthermore, provision may for example be made for the container to be able to be decoupled or removed from the lower receptacle.

In a further advantageous refinement, provision may be made for the securing station to be designed to perform a method claimed above.

It is particularly advantageous in this case that the advantages of the method already claimed can thus be implemented.

In a further advantageous refinement, provision may be made for the securing station to be part of a process machine, wherein the process machine has a delimitation which forms a clean room, in particular an isolator or an RABS, wherein the securing station is in the clean room.

RABS (restricted access barrier system) refers to clean rooms which are used for example in the pharmaceutical industry for aseptic production. Here, a distinction can be made between O-RABS (open restricted access barrier system, open RABS) and C-RABS (closed restricted access barrier system, closed RABS).

This enables a broad application of the invention in pharmaceutical installations, for example for automatically filling containers with a substance.

It is particularly advantageous that the securing station, the container with stopper and the closure cover can thus be protected in particular against contaminants.

In a further advantageous refinement, provision may be made for the at least one sensor, in particular motion sensor, to be designed to detect a movement quantity of the relative movement, in particular pulses at an encoder, a travelled angle, a rotational speed and/or a torque.

It is thus advantageously possible for the sensor to be used to detect various measured values which can be used either individually or in combination with one another to assess the quality of the securing. Furthermore, provision may for example be made for multiple sensors to be configured at different positions, as a result of which in turn it is advantageously possible for the measured values to be validated and/or verified with respect to one another and measurement inaccuracies or measurement errors can be depleted.

By way of example, provision may also be made for the at least one motion sensor to be a Hall sensor and/or to be oriented transversely with respect to a longitudinal extent of the securing station, in particular transversely with respect to a shaft on which the upper receptacle is preferably mounted by way of an axial bearing.

As an alternative or in addition, optical sensors, bend sensors (e.g. strain gauge) and piezoelectric sensors can be used.

In a further advantageous refinement, provision may be made for the securing station to have a drive unit in particular for the receptacle, and/or wherein the drive unit preferably comprises a linear drive, preferably a pneumatic cylinder.

It is thus for example possible for the receptacles to be compressed against one another in such a way that virtually slip-free movement can advantageously be implemented between the driving receptacle and the concomitantly operating receptacle. It is also particularly favourable that an axial compression force is maintained over a time span of the securing for example by way of a pneumatic cylinder with corresponding control system, in particular pneumatic valves.

Furthermore, provision may for example be made for the linear drive to be in particular of self-locking design, for example in the form of an electric cylinder.

In a further advantageous refinement, provision may for example be made for at least two securing stations to be present, which can preferably be controlled in open-loop and/or closed-loop fashion independently of one another.

It is thus particularly advantageous that in particular complications which may occur for example at one securing station do not lead to an interruption of the method at the at least one other securing station. It is thus also advantageously possible for the securing method to run on multiple containers in parallel, making it possible to reduce cycle times.

Furthermore, it is advantageous that complications can be identified at an early stage and eliminated.

In a further advantageous refinement, provision may be made for the securing station to have at least two motion sensors, wherein one of the at least two motion sensors is designed to detect the movement quantity of the lower receptacle and the second motion sensor is designed to detect the movement quantity of the upper receptacle.

It is thus particularly advantageous that a comparison of the two movement quantities, for example of the rotational speeds, is possible, wherein slip between the driving receptacle and the concomitantly operating receptacle can provide information that a readjustment for example of one of the two movement quantities should be effected.

The readjustment provided may for example also be an exchange of the supports. In addition, provision may for example be made for the motion sensor of the lower receptacle to preferably be integrated in a motor which drives the lower receptacle.

As an alternative or in addition, the features of the additional independent claim, which is directed to a securing station, are provided according to the invention in order to achieve the stated object. In particular, in order to achieve the stated object in the case of a securing station of the type described in the introduction, it is thus proposed that the securing station has at least one force measuring sensor which is designed to detect a force contribution, in particular a pressing force of the securing along a pressing, said pressing force being able to be generated by the securing tool.

The securing tool, in particular the or a crimping disc, may preferably be exchangeably arranged on the securing station.

It is particularly advantageous that it is thus for example possible to ascertain whether the pressing force of the securing tool is too low, too high, or is optimally set for carrying out the securing. It is also advantageous that, by way of an optimally set pressing force of the securing tool, the number of incorrectly secured containers can be greatly reduced and costs can also particularly advantageously be saved.

### BRIEF DESCRIPTION OF THE DRAWINGS

The invention will now be described in more detail with reference to an exemplary embodiment, but is not restricted to the exemplary embodiment. Further exemplary embodiments emerge from combining the features of individual or multiple claims with one another and/or with individual or multiple features of the exemplary embodiment.

In the figures, in each case in a greatly simplified illustration:

FIG. 1 shows a two-dimensional illustration of a securing station with an upper and lower receptacles, container, stopper, closure cover and securing tool with crimping disc, a delimitation of a process machine forming a clean room,

FIG. 2 shows a two-dimensional illustration of a further securing station according to the invention with bearing arrangement and strain gauge,

FIG. 3 shows a two-dimensional illustration of a further securing station according to the invention with two motion sensors,

FIG. 4 shows a two-dimensional illustration of a securing station according to the invention with axial compression of the upper and lower receptacles and engagement of the securing tool,

FIG. 5 shows a schematic illustration of a method for securing a stopper by means of a closure cover, the force contributions and the movement quantities being illustrated for the method steps,

FIG. 6 shows an illustration of the temporal profiles of the force contributions and movement quantities of the method steps in two-dimensional coordinate systems,

FIG. 7 shows a two-dimensional illustration of the securing method for multiple securing stations operating in parallel in a process machine, and

FIG. 8 shows a two-dimensional illustration of the method according to FIG. 7 with methods that have been interrupted at two securing stations on account of complications that have occurred.

### DETAILED DESCRIPTION

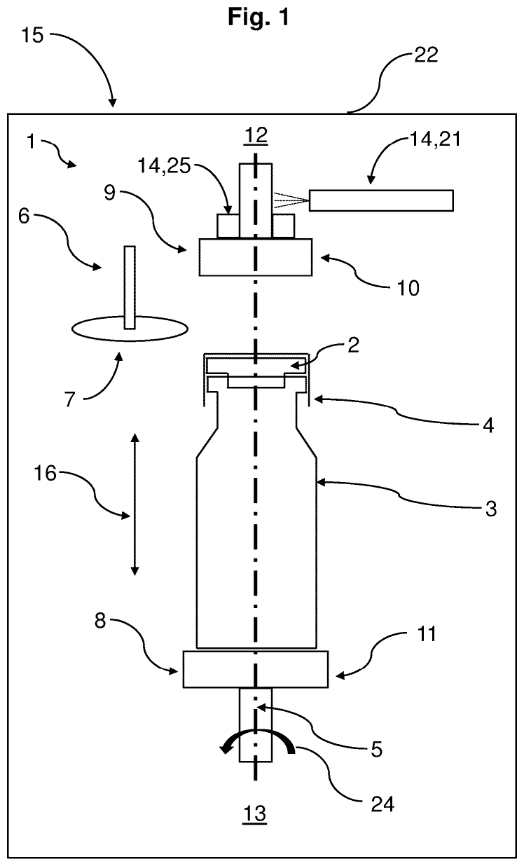

FIG. 1 shows a securing station 1, denoted overall by 1, for carrying out a method for securing a container 3 closed by a stopper 2. The stopper 2 of the container 3 is inserted in this case into an opening in the container 3, a closure cover 4 being positioned above the stopper 2 on the container 3.

The securing station 1 has a securing tool 6 with a crimping disc 7.

The container 3 and the closure cover 4 are arranged so as to be movable relative to one another along an axis 5.

The container 3 is positioned on a lower rotatably driving receptacle 8, 11. The lower receptacle 11 has a drive unit, the drive unit not being shown. In this case, the drive unit may, for example, comprise a linear drive, preferably a pneumatic cylinder, for axial displacement (compression/release) and a rotary drive for setting the receptacle into a rotational movement 24, at a fixedly predefined rotational speed.

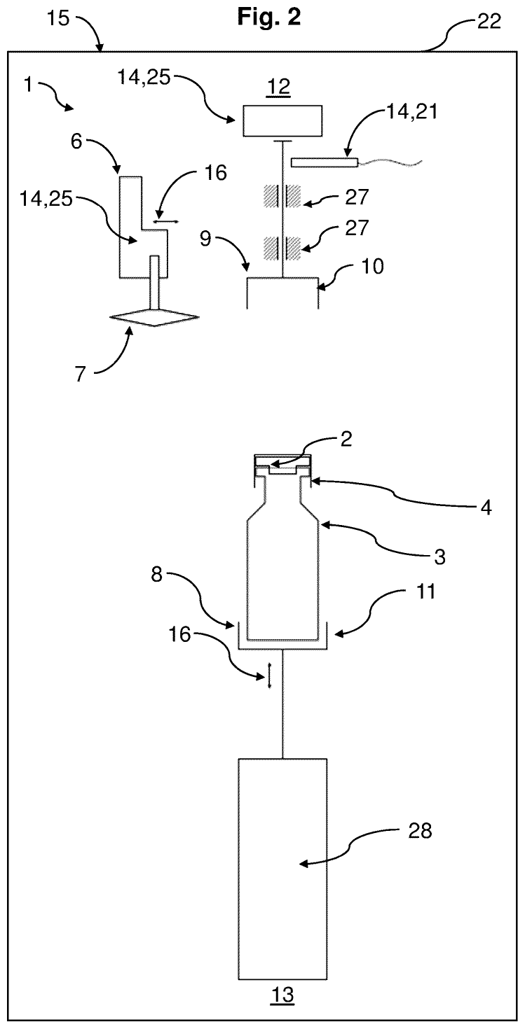

Configured above the closure cover 4 is an upper, rotatably concomitantly operating receptacle 9, 10. In this exemplary embodiment, a sensor 14 for detecting a quantity 20 determined at least by a relative movement between the container 3 and the closure cover 4 about the axis 5 is configured transversely with respect to a longitudinal extent of a shaft of the upper receptacle 10 (cf. FIG. 2). The sensor 14 shown in this exemplary embodiment is an encoder 21 which detects pulse spacings of the upper receptacle 10 in order to determine a movement quantity 18.

In a further exemplary embodiment, provision is made for the sensor 14 to detect an acceleration of the relative movement.

In further exemplary embodiments, the sensor 14 may be designed to detect a travelled angle, a rotational speed and/or a torque of container 3, receptacle(s) 10, 11, crimping disc 7 and/or closure cover 4.

The upper, concomitantly operating receptacle 9, 10 forms the concomitantly operating side 12, the lower, driving receptacle 8, 11 designating the driving side 13.

In a further exemplary embodiment, this may be reversed.

In a further exemplary embodiment, a difference in the rotational speeds between the receptacle 11 and the container 3 and/or a difference in rotational speeds between the receptacle 10 and the closure cover 4 may also be detected as quantity. This leads to a quantity which characterizes a coupling or slip at the lower receptacle 11 and/or the upper receptacle 10.

In the exemplary embodiment shown, the receptacles 10, 11 can be compressed together in a pressing direction 16.

The securing station 1 is part of a process machine which has a delimitation 22 forming a clean room 15, in particular an RABS (Restricted Access Barrier System, closed C-RABS or open O-RABS) or isolator. The securing station 1 can thus be protected in particular against contaminants.

In this exemplary embodiment, a force measuring sensor 25 in the form of a load cell is configured on the upper receptacle 10 and detects an axial compression force between the lower receptacle 11 and the upper receptacle 10.

In a further exemplary embodiment (not shown), provision is made for the sensor 14 to be arranged such that the movement quantity 18 is determined, in this case this is the measured pulses per unit time of the relative movement of the lower and/or driving receptacle 8, 11 in relation to the closure cover 4 of the container 3. Furthermore, in exemplary embodiments that are not shown, provision is also made for the sensors 14 to be arranged in order to determine the movement quantity 18 of the relative movement of the closure cover 4 and/or of the crimping disc 7 in relation to the container 3 and/or of the crimping disc 7 in relation to the upper receptacle 10.

FIG. 2 shows, in addition to FIG. 1, a further exemplary embodiment according to the invention of a securing station 1.

In this case, the concomitantly operating side 12 is provided with a bearing arrangement 27. In the exemplary embodiment shown, the force measuring sensor 25 is configured in the form of a strain gauge on the concomitantly operating side 12.

The securing tool 6 is horizontally movable, as a result of which a pressing force can be generated in the pressing direction 16 and is maintained by way of the application force of the securing tool 6 during the securing. A further force measuring sensor 25 integrated in the securing tool 6 is designed to detect the pressing force and/or application force of the securing tool 6, in particular of the crimping disc 7. Another sensor 14 integrated in the securing tool 6 additionally measures the adjustment path of the securing tool 6. The driving receptacle 8 is connected to a drive unit 28.

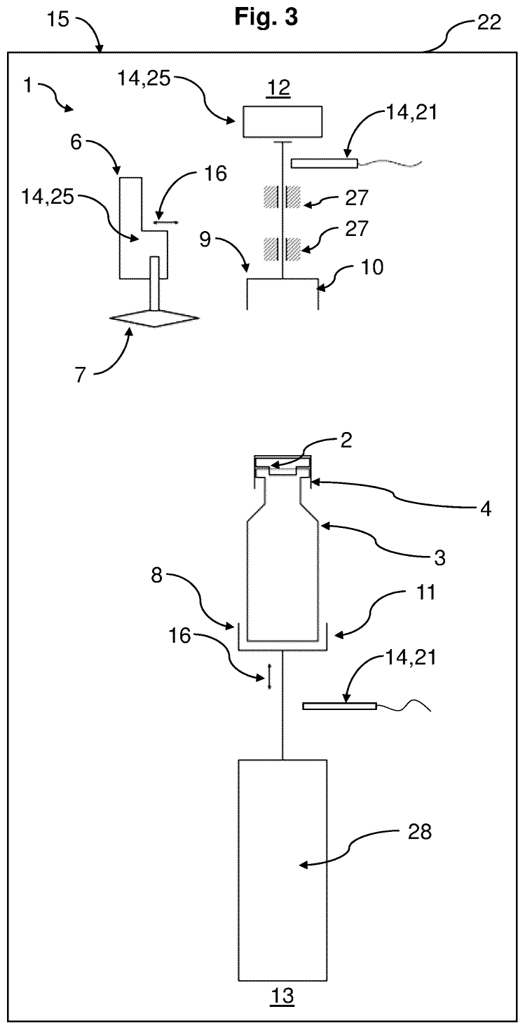

FIG. 3 shows a further securing station 1 according to the invention with a second motion sensor 21 which is additionally designed to detect the movement quantity 18 of the lower receptacle 11. The rotational movement quantity 18 of the lower driving receptacle 8, 11, which forms a reference value of the movement quantity 18, is thus detected by way of a further sensor 14.

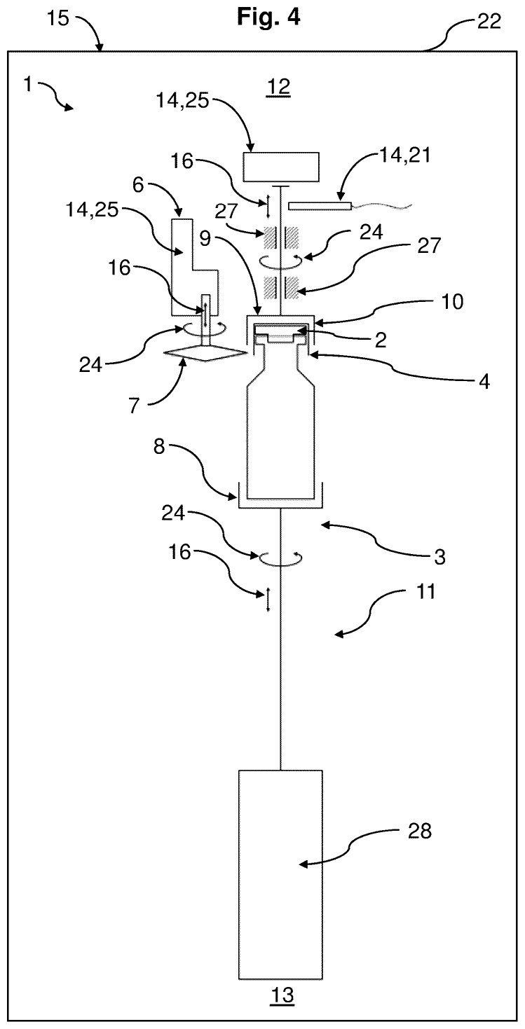

FIG. 4 shows the upper receptacle 10 and the lower receptacle 11 in a compressed state. The crimping disc 7 of the securing tool 6, the driving receptacle 8 and the concomitantly operating receptacle 9 perform a rotational movement 24. In order to maintain the compression force, the lower and/or upper receptacle carries out an axial displacement in the pressing direction 16.

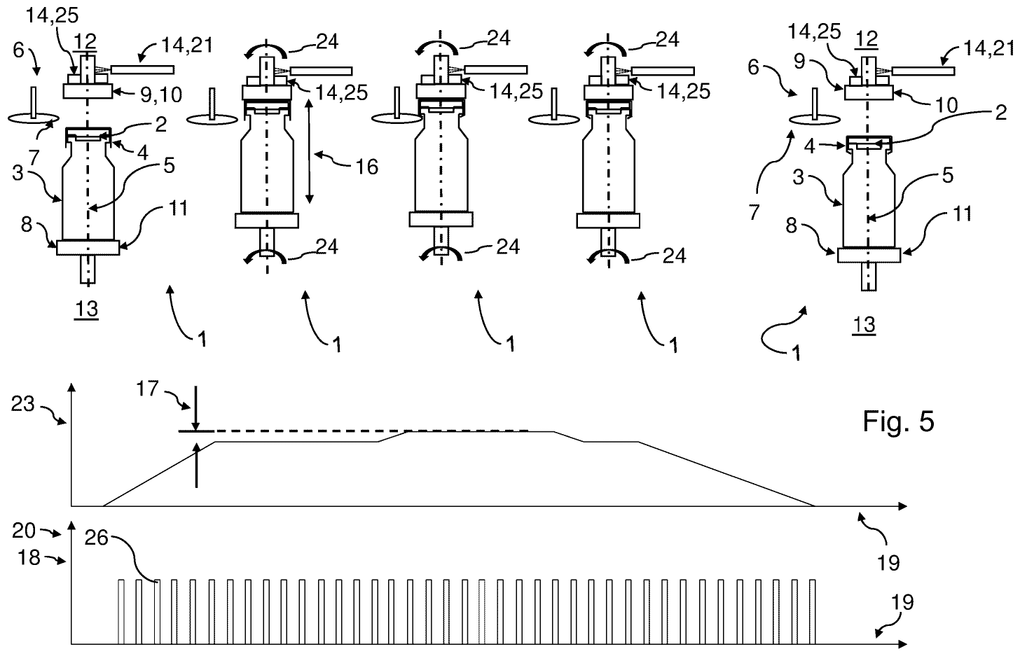

FIG. 5 shows the various method steps of the securing station 1 from left to right, said steps being carried out in order to secure the stopper 2 on the container 3 by means of the closure cover 4.

In addition, illustrated in each case in a two-dimensional coordinate system below the respective method steps are forces 23 and movement quantities 18 detected by the sensors 14 over a detection time period 19 comprising the time span of the securing. In this case, the detection of the relative movement is started prior to the securing and concluded after the securing.

In a first method step, the securing tool 6, in particular the crimping disc 7, is not in engagement.

In the exemplary embodiment shown, the time between two pulses 26 which are transmitted to the encoder 21 is detected as a measure for the movement quantity 18 of the rotational movement 24 of the upper receptacle 10 and illustrated in the coordinate system. It can be seen in the coordinate system that the upper receptacle 10 and the lower receptacle 11 initially do not perform a rotational movement 24, since no contacting is effected between the lower receptacle 11 and the upper receptacle 10 at the beginning of the securing.

At the same time, the force 23 is measured by way of the force measuring sensor 25 in order to detect the movement quantity 18, with the result that the detection time period 19 of the movement quantity 18 and the detection time period 19 of the force 23 at least partially overlap in terms of time, in particular during the time span of the securing.

Thus, in the case of a constant rotary movement of the driving side 13, pulses 26 which are uniformly spaced are generated on the concomitantly operating side 12.

It can be seen that the force 23 is non-existent at the beginning of the securing, since the upper and lower receptacles 10, 11 are not compressed against one another and the securing tool 6 of the crimping disc 7 is not in engagement.

In a further method step, the container 3 with stopper 2 and closure cover 4 is compressed by the upper and the lower receptacle 10, 11, the upper receptacle 10 engaging with the container 3 from above. In this way, the force 23 increases.

It can thus be said that the container 3 with the stopper 2 and the closure cover 4 are compressed against one another.

The lower receptacle 11, which engages with the container 3 from below and on which the container 3 is arranged, is then driven by the drive unit 28, as a result of which there is preferably a rotational movement 24 about the axis 5 between the container 3 and the closure cover 4.

The rotational movement 24 is thus transmitted from the lower, driving receptacle 8, 11 to the upper, concomitantly operating receptacle 9, 10. This is also reflected in the coordinate system, in which the pulses 26 detected by the encoder 21 are then illustrated.

It is also apparent that, owing to the axial compression between the upper and lower receptacles 10, 11, a force 23 of the compression that is initially increasing and then, for example after a stop has been reached or pressure control has been deactivated, constant is detected. The axial compression force is maintained. In order to maintain the compression force, the lower and/or upper receptacle 10, 11 can carry out an axial displacement.

Furthermore, it can be seen that the movement quantity 18 of the concomitantly operating receptacle 9 is consistent or constant, since the pulse spacings of the pulses 26 are consistent, as a result of which it can be assumed that the upper and lower receptacles 10, 11 have identical movement quantities 18.

In a next method step, first contacting between the closure cover 4 of the container 3 and the crimping disc 7 of the securing tool 6 is effected.

A measurement of an application force of the securing tool 6 transversely with respect to the pressing direction 16 results in a further increase in the force 23 by a force contribution 17 which is produced by virtue of the fact that the closure cover 4 is folded over by a pressing force of the securing tool 6, in particular by a pressing force of the crimping disc 7, and is thus detected by the force measuring sensor 25.

In this case, the pressing force results from the application force of the securing tool 6, in particular of the crimping disc 7. Here, the pressing force is maintained by way of the application force of the securing tool 6 during the securing.

Thus, in addition to the axial compression force, the force 23 comprises a pressing force of the securing tool 6, in particular of the or a crimping disc 7, as force contribution 17, which can thus be monitored constantly and assessed.

In a further exemplary embodiment (not shown), provision is also made for a measurement of an adjustment path of the securing tool 6, in particular transversely with respect to the force contribution 17 and/or longitudinally with respect to the force contribution 17 of the securing tool 6, in particular of the crimping disc 7, to be effected during the force contribution 17.

In a next method step, the securing tool 6, in particular the crimping disc 7, is displaced by a restoring force, such that the securing tool 6, in particular the crimping disc 7, is no longer in engagement. The restoring force of the securing tool 6 is measured during the force contribution 17 longitudinally with respect to the pressing direction 16.

The restoring force brings about a decrease in the pressing force of the securing tool 6, in particular of the crimping disc 7. This is reflected in a reduction in the force contribution 17. The detected force 23 is thus reduced to the axial compression force of the upper and lower receptacles 10, 11 which was already detected in a preceding method step.

In a next method step, the pressing between the container 3 with stopper 2 and the closure cover 4 by the upper and lower receptacles 10, 11 is reduced until there is no longer any force 23 detected. The securing is thus concluded and the container 3 can be decoupled from the lower receptacle 11, once the latter is no longer driven.

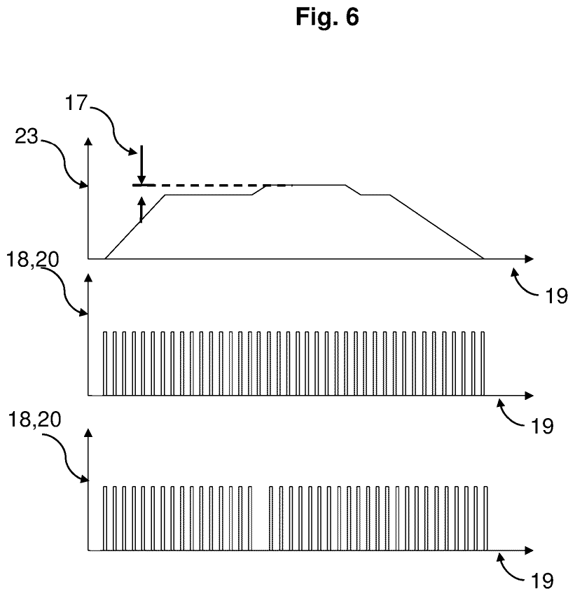

FIG. 6 once again shows the forces 23, force contributions 17 and movement quantities 18 of the method that are recorded in the two-dimensional coordinate systems over the entire detection time period 19 of the securing. In contrast to FIG. 5, a further two-dimensional coordinate system is additionally shown in which an irregular profile of the movement quantity 18 of the relative movement is detected and illustrated over the detection time period 19 of the securing. This may, for example, be due to the fact that a coupling between the upper and the lower receptacles 10, 11 is not sufficient, for example as a result of soiling, to transmit the rotational movement 24 of the lower receptacle 11 to the upper receptacle 10 in a slip-free manner. The measurement of the movement quantity 18 of the relative movement makes it possible to quickly identify, assess and eliminate errors.

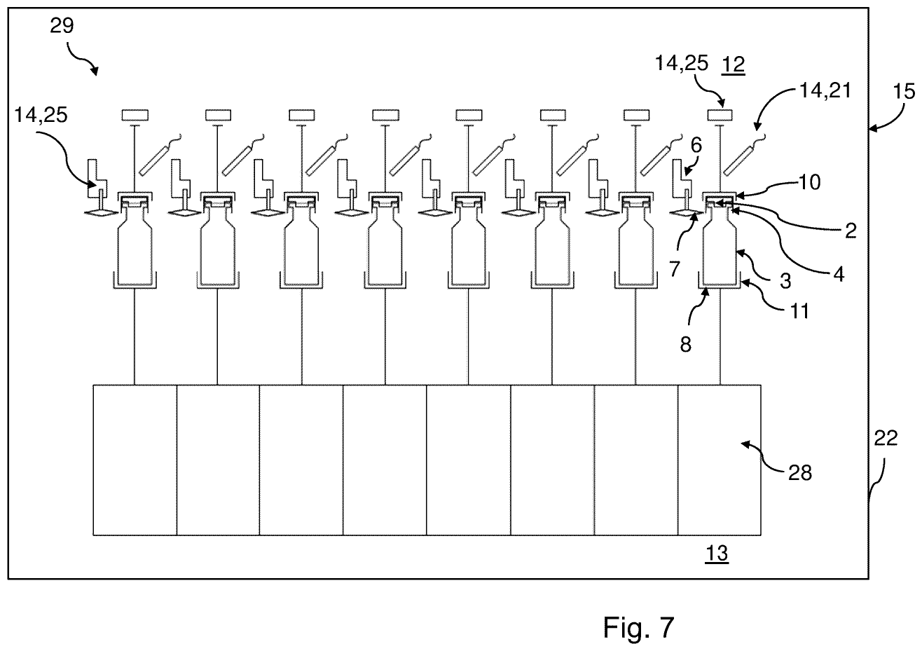

FIG. 7 shows eight securing stations 1 of the process machine, the securing method running at each securing station 1 in parallel and independently of one another. The lower and upper receptacles 10, 11 are compressed together at each securing station 1.

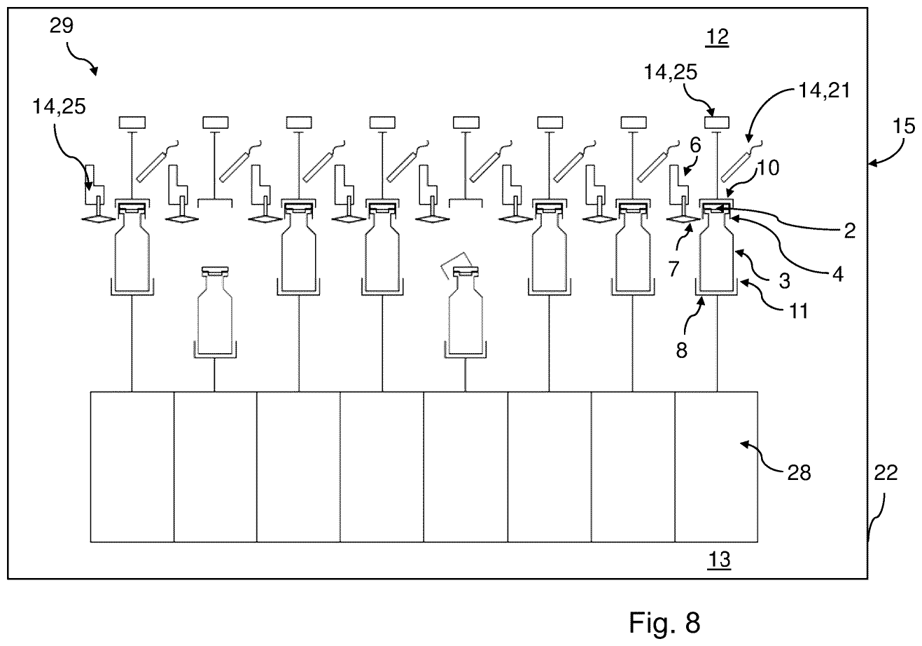

FIG. 8 also shows eight securing stations 1 of the process machine, which run independently of one another. At six securing stations 1, the lower and upper receptacles 10, 11 are compressed together and the securing tool 6 is in engagement.

At the second securing station 1 from the left, the securing method is interrupted, independently of the other securing stations 1, and the upper and the lower receptacle 10, 11 are not compressed together. Here, it has been identified that the closure cover 4 is not fitted on the container 3. The method has thus been interrupted in a timely manner. This allows the closure cover 4 to be refitted on the container 3, without a reject having been produced.

At the fifth securing station 1 from the left, the securing method is also interrupted independently of the further securing stations 1. Here, it is evident that the closure cover 4 is fitted incorrectly, clearly lopsidedly, on the container 3. Here, too, timely interruption of the method makes it possible to prevent a reject as a result of a container 3 that is qualitatively not sufficiently closed. The invention thus proposes, in a method for securing a stopper 2 on a container 3 by means of a closure cover 4 with the aid of a securing station 1, that, during the securing, measurements of quantities 20, in particular movement quantities 18, about an axis 5 are carried out in order to assess the securing operation and the detected measured values are assessed in order to detect insufficiently secured containers 3.

### LIST OF REFERENCE SIGNS

1 Securing station
2 Stopper
3 Container
4 Closure cover
5 Axis
6 Securing tool
7 Crimping disc
8 Driving receptacle
9 Concomitantly operating receptacle
10 Upper receptacle
11 Lower receptacle
12 Concomitantly operating side
13 Driving side
14 Sensor
15 Clean room
16 Pressing direction
17 Force contribution
18 Movement quantity
19 Detection time period
20 Quantity
21 Encoder
22 Delimitation
23 Force
24 Rotational movement
25 Force measuring sensor
26 Pulse
27 Bearing arrangement
28 Drive unit
29 Process machine

1. A method for securing a stopper (2) on a container (3) using a closure cover (4), the method comprising:
during the securing, performing a relative movement at least between the closure cover (4) and a securing tool (6) about an axis (5); and
during the securing, carrying out a detection of a quantity (20) determined at least by a relative movement between the container (3) and the closure cover (4) about the axis (5).

2. The method according to claim 1, wherein, during the securing, the detection of the quantity is determined by carrying out at least one of a) a rotationally connected coupling of the container (3) by a coupling of a receptacle (8, 11) which contacts the container (3) to the container (3), or b) a rotationally connected coupling of the closure cover (4) by a coupling of a receptacle (10) which contacts the closure cover (4) to the closure cover (4).

3. The method according to claim 1, wherein the quantity (20) is effected by measurement of a rotary relative movement between a receptacle (8), which contacts the container (3), and a concomitantly operating receptacle (9) which receives the closure cover (4).

4. The method according to claim 3, wherein the quantity (20) is an absolute value based on at least one of the concomitantly operating side receptacle or the driving side which contacts the container (9, 8), a time between pulses at an encoder (21), a travelled angle, a rotational speed, or an acceleration value.

5. The method according to claim 1, wherein the quantity (20) is determined from a measurement of at least one of a) a relative movement of a lower and/or driving receptacle (11, 8) for the container in relation to the closure cover (4) of the container (3), b) a relative movement of an upper and/or concomitantly operating receptacle (10, 9) in relation to the container (3), c) a relative movement of the closure cover (4) in relation to the container (3) and/or of a crimping disc (7) in relation to the container (3) or relative movement of the crimping disc (7) in relation to a upper and/or concomitantly operating receptacle (10, 9).

6. The method according to claim 1, further comprising compressing the container (3) with the stopper (2) and the closure cover (4) by an upper and/or concomitantly operating and lower and/or driving receptacle (10, 11), such that a rotational movement of the lower and/or driving receptacle (11, 8) is transmitted to the upper and/or concomitantly operating receptacle (10, 9).

7. The method for securing a stopper (2) on a container (3) using a closure cover (4), the method comprising:
carrying out at least one of a) a rotationally connected coupling of the container (3) by a coupling of a receptacle (8, 11) which contacts the container (3) to the container (3), or b) a rotationally connected coupling of the closure cover (4) by a coupling of a receptacle (10) which contacts the closure cover (4) to the closure cover (4);
ascertaining a relative movement of the container (3) and the closure cover (4); and
comparing the ascertained relative movement with at least one rotational drive movement of at least one of the receptacles (8, 9).

8. The method according to claim 7, further comprising, during the detection, providing a setpoint value of a movement quantity (18) of the relative movement by a specification, and the setpoint value of a driving side (13) of the container (3) is provided and the setpoint value is compared with an ACTUAL value of a concomitantly operating side (12).

9. A method for securing a stopper (2) on a container (3) using a closure cover (4), wherein the container (3) is a pharmaceutical or medical container (3), the method comprising:
during the securing, performing a relative movement at least between the closure cover (4) and a securing tool (6) about an axis (5);
compressing the container (3) with the stopper (2) and the closure cover (4) against one another in a pressing direction (16); and
detecting a force contribution (17) of the securing during the compressing.

10. The method according to claim 9, further comprising, effecting a measurement of an application force of the securing tool (6), during the force contribution (17) transversely with respect to the pressing direction (16).

11. The method according claim 9, further comprising effecting a measurement of a restoring force of the securing tool (6) during the force contribution (17) longitudinally with respect to the pressing direction (16).

12. The method according to claim 9, further comprising effecting a measurement of an adjustment path, at least one of transversely with respect to the force contribution (17) or longitudinally with respect to the force contribution (17), of the securing tool (6), during the force contribution (17).

13. The method according to the preceding claim 12, further comprising maintaining a compression force acting on the container (3) during a detection time period (19) of the force contribution (17), which comprises at least a time span of the securing.

14. The method according to claim 13, wherein, in order to maintain the compression force, a lower and/or concomitantly operating receptacle (11, 9) acting on the container (3) carries out an axial displacement during the time span of the securing.

15. The method according to claim 13, wherein the force contribution (17) comprises a pressing force of the securing tool (6), and the pressing force is ascertained and assessed.

16. The method according to claim 13, wherein the detection time period (19) of the movement quantity (18) and the detection time period (19) of the force contribution (17) at least partially overlap in terms of time.

17. A securing station (1) for securing a container (3), closed by a stopper (2), using a closure cover (4), wherein the container (3) and the closure cover (4) are arranged so as to be movable relative to one another along an axis (5), the securing station (1) comprising:
at least one securing tool (6) for securing the closure cover to the container;
at least one sensor (14) configured to detect a quantity determined at least by a relative movement between the container (3) and the closure cover (4) about the axis (5).

18. A securing station (1) for securing a container (3), closed by a stopper (2), using a closure cover (4), wherein the container (3) and the closure cover (4) are arranged so as to be movable relative to one another along an axis (5), the securing station (1) comprising:
at least one securing tool (6) for securing the closure cover to the container;
at least one sensor (14) configured to detect a quantity determined by at least one of a rotationally connected coupling of the container (3), or by a rotationally connected coupling of the closure cover (4).

19. The securing station (1) according to claim 18, further comprising a lower rotatable, driving receptacle (11, 8) on which the container is positionable, and an upper rotatable, concomitantly operating receptacle (10, 9) on which the closure cover (4) is positionable.

20. The securing station (1) according to claim 19, wherein the securing station (1) is configured to, during the securing, perform a relative movement at least between the closure cover (4) and a securing tool (6) about an axis (5), and during the securing, carry out a detection of the quantity (20) determined at least by a relative movement between the container (3) and the closure cover (4) about the axis (5).

21. The securing station (1) according to claim 20, wherein the securing station (1) is part of a process machine (29), the process machine (29) has a delimitation (22) which forms a clean room (15), and the securing station (1) is in the clean room (15).

22. The securing station (1) according to claim 18, wherein there are at least two of the securing stations (1), which are controllable in at least one of open-loop or closed-loop fashion independently of one another.

23. The securing station (1) according to claim 19, further comprising at least two motion sensors, wherein one of the at least two motion sensors is configured to detect the movement quantity (18) of the lower receptacle (11) and the other of the at least two motion sensors is configured to detect the movement quantity (18) of the upper receptacle (10).

24. The securing station (1) according to claim 23, wherein the container (3) is a pharmaceutical or medical container (3), the container (3) and the closure cover (4) are arranged so as to be movable relative to one another along the axis (5), and at least one force measuring sensor is configured to detect a force contribution (17) of a pressing force generated by the securing tool (6).
